(19) United States
(12) Patent Application Publication
(10) Pub. No.: US 2011/0264483 A1
(43) Pub. Date: Oct. 27, 2011

(54) DYNAMIC COLLABORATIVE ADAPTATION OF A BUSINESS ACTIVITY IN A BUSINESS ACTIVITY MANAGEMENT SYSTEM

(76) Inventors: Hamid Reza Motahari Nezhad, Sunnyvale, CA (US); Sven Graupner, Mountain View, CA (US); Sharad Singhal, Belmont, CA (US); Sujoy Basu, Sunnyvale, CA (US)

(21) Appl. No.: 12/768,174

(22) Filed: Apr. 27, 2010

(51) Int. Cl. G06Q 10/00; G06F 15/16; G06F 3/048

(52) U.S. Cl. 705/7.27; 705/301; 705/300; 715/738

(57) ABSTRACT

Dynamic adaptation of a business activity involves creation and updating of the business activity in an ad-hoc and collaborative manner as the business activity executes. User input relating to creation of a business activity is received through a user portal, where the business activity involves interactions among people. A business activity orchestrator orchestrates execution of work in the business activity. The business activity is updated using a business activity adapter, where updating the business activity occurs during execution of the business activity, and the updating is further responsive to collaborative input of the people involved in the business activity.

### BACKGROUND

A business environment can involve interactions among people, including people within the same organization or people in different organizations. An organization can be a company, an educational organization, a government agency, any department or division thereof, or others. The interactions among people can be complex to understand and manage.

### BRIEF DESCRIPTION OF THE DRAWINGS

Some embodiments are described with respect to the following figures:

FIG. 1 is a flow diagram of a business activity management process according to some embodiments;

FIG. 2 is a block diagram of an architecture of a business activity manager according to some embodiments;

FIG. 3 is a flow diagram of a business activity management process according to further embodiments;

FIG. 4 illustrates a user interface provided by the business activity manager according to some embodiments; and

FIG. 5 is a block diagram of an example arrangement incorporating some embodiments.

### DETAILED DESCRIPTION

In accordance with some embodiments, a business activity management mechanism or technique is provided to allow for dynamic adaptation of a business activity. Dynamic adaptation of the business activity involves creation and updating of the first business activity in an ad-hoc and collaborative manner as the business activity executes. “Dynamic” adaptation means that the adaptation can be performed at any time during definition and progression (execution) of a business activity. Adaptation of the business activity in a collaborative manner refers to adaptation based on collaboration among multiple users. Ad-hoc adaptation of the business activity refers to definition and updating of the business activity that does not involve a predefined definition of the business activity, such that the business activity can be continually defined on the fly during execution of the business activity.

A “business activity” refers to a collection of tasks or other discrete pieces of work, where the business activity involves interactions among people (two or more users). Examples of business activities include data entry, human resource management, outsourcing management, project development, or other types of activities. A business activity refers to an activity that can be performed by an organization or by a collection of organizations. Examples of organizations include companies, education organizations, government agencies, departments or divisions of such organizations, or other types of organizations.

Conventionally, predefined and fixed descriptions or models of business activities are usually defined to perform business activity management. However, such predefined and fixed descriptions or models of business activities cannot be used to support interactions among people in an ad hoc and flexible manner. Typically, interactions among people are ad-hoc, dynamic, and complex. Individuals often use productivity tools (e.g., word processing tools, spreadsheet tools, etc.) in performing business activities, which can add to complexity and may result in reduced efficiency. Moreover, best practices are often defined to provide guidelines regarding performance of business activities. Best practices refer to a collection of established and documented techniques, processes, activities, and/or systems that are more effective at delivering a target outcome than other techniques, processes, activities, and/or systems. However, best practices may not be followed by individuals working on business activities due to the ad-hoc nature of collaboration among the individuals.

In accordance with some embodiments, to allow for more flexible business activity management, a business activity manager is provided that allows for dynamic adaptation of business activities based on ad-hoc collaboration among users involved in the business activities. In some implementations, the business activity manager includes a user portal, a business activity adapter, and a business activity orchestrator.

The business activity manager according to some implementations allows for an efficient and flexible way of defining, orchestrating, and adapting ad hoc and dynamic business activities that involve interactions among people. The ability to collaboratively update the business activity allows multiple users to perform the update(s) in a relatively efficient manner. In some implementations, fixed or rigid models of business activities do not have to be predefined, and users do not have to be tasked with manipulating such models, which can be complex and difficult to understand or use. The business activity manager is able to capture information as people work on a business activity such that the business activity can form and manage any model on the behalf of users.

The definitions of business activities, and identification of inter-dependencies among business activities, as well as dynamic modifications of any dependency model relating to the business activities, are performed on the fly by the business activity manager during execution of the business activities. The definition/modification of a business activity is triggered by events that result from high-level actions performed by people using various productivity tools and as a team (collaboratively). Events can also be triggered by people themselves as they collaborate and this collaboration involves interaction with other people. “Productivity tools” refer to tools that are typically provided to users to perform various tasks or other pieces of work, such as word processing tools, spreadsheet tools, email tools, calendaring tools, project management tools, and/or other types of tools.

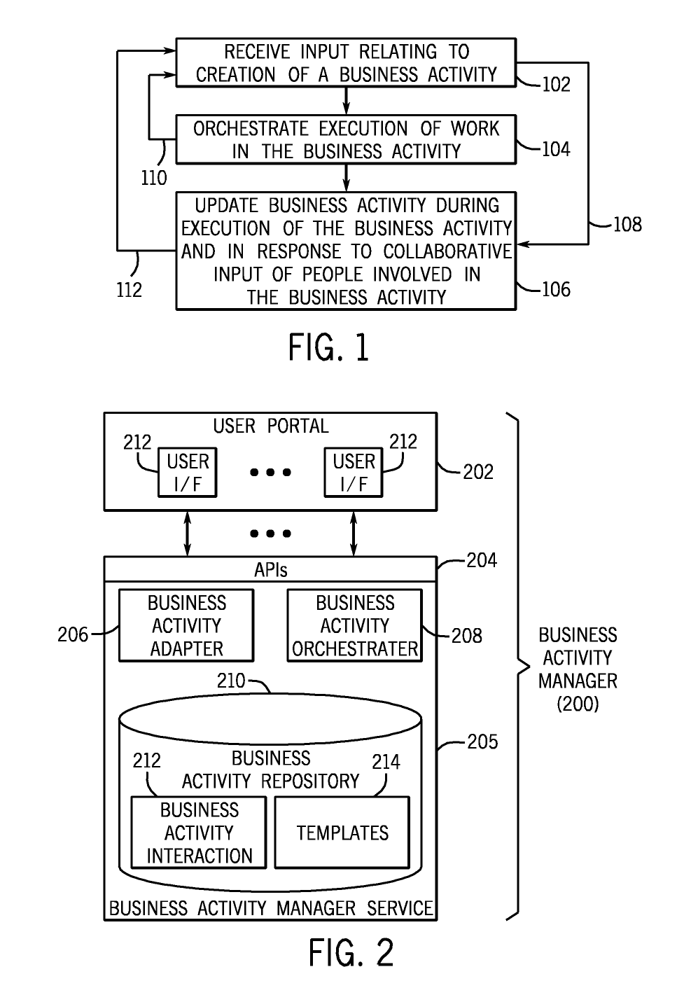

A process of business activity management according to some embodiments is depicted in FIG. 1. In the process of FIG. 1, user input relating to creation of a business activity is received (at 102) through the user portal (e.g., a web-based portal). The user portal presents multiple user interfaces at corresponding client devices associated with multiple users. The activity orchestrator is able to orchestrate (at 104) execution of work in the business activity. In addition, the business activity can be updated (at 106) using the business activity adapter. Updating the business activity occurs during execution of the business activity and is in response to collaborative input of the people involved in the business activity. In the procedure of FIG. 1, creation and updating of the business activity are performed in an ad-hoc and collaborative manner as the business activity executes “Execution” of a business activity refers to performance of tasks or other pieces of work of the business activity. Updating a business activity in response to collaborative input of people involved in the business activity refers to updating the business activity in response to multiple users submitting inputs through the user portal (such as through corresponding workspaces) relating to update(s) of the business activity.

FIG. 1 also shows an arrow 108 from box 102 to box 106; this indicates that upon receiving inputs from users, the business activity definition is considered updated. FIG. 1 also shows arrows 110 and 112 from boxes 104 and 106, respectively, back to box 102. Arrows 110 and 112 show that the FIG. 1 procedure is a continual procedure, which means that the input receiving, orchestrating, and updating tasks are continually performed.

A business activity can involve multiple members of a team. As the business activity executes, based on orchestration by the business activity orchestrator, the team members can determine that the business activity should be updated, such as by adding tasks, updating tasks, removing tasks, adding a group of tasks, removing a group of tasks, updating a group of tasks, adding a step to a particular task, removing a step from a particular task, updating a step in a particular task, adding a team member, removing a team member, and/or allowing a user to join a team that is working on the business activity.

FIG. 2 is a block diagram of a business activity manager 200 according to some implementations (which is able to perform the process of FIG. 1). The business activity manager 200 includes a user portal 202, an interface layer 204 that is communicatively connected to the user portal 202, a business activity adapter 206, and a business activity orchestrator 208.

The business activity adapter 206 enables definition of a new business activity, and also allows for updating of the business activity at run time (during execution of the business activity). The business activity orchestrator 208 keeps track of the execution of a business activity, and automatically coordinates the flow of tasks and steps of the business activity among people based on dependencies between tasks and task groups of the business activity. A “task group” refers to a group of tasks that have been logically associated with each other.

In addition, a business activity repository 210 is provided in the business activity manager 200, where the business activity repository 210 stores information 212 relating to business activities definitions as well as on-going execution of business activities. The business activity repository 210 can also store templates 214 used for creation of business activities.

The business activity adapter 206, business activity orchestrator 208, and business activity repository 210 are considered to be part of a business activity manager service 205 of the business activity manager 200. The business activity manager service 205 is able to communicate with the user portal 202 through the interface layer 204.

The user portal 202 includes user interfaces 212 that can execute at corresponding client devices associated with different users. Examples of client devices include desktop computers, notebook computers, personal digital assistants, or other types of devices. The interface layer 204 wraps and exposes the functionality of the business activity manager 200 to allow for ease of access of the business activity manager 200 by external client devices through the user interfaces 212. For example, each of the user interfaces 212 can be in the form of a wizard that supports user interaction. Other types of interactive user interfaces 212 can be used in other implementations.

In some examples, the interface layer 204 can wrap and expose the functionality of the business activity manager 200 as a web service (such that users are presented with web-based content, such as web pages, to allow interaction between the users and the business activity manager service 205).

In some implementations, the interface layer 204 includes a set of application programming interfaces (APIs). The APIs can be called to perform various actions with respect to business activities, such as defining a business activity, updating a business activity, deleting a business activity, and so forth. An API is a routine invocable to perform a target action.

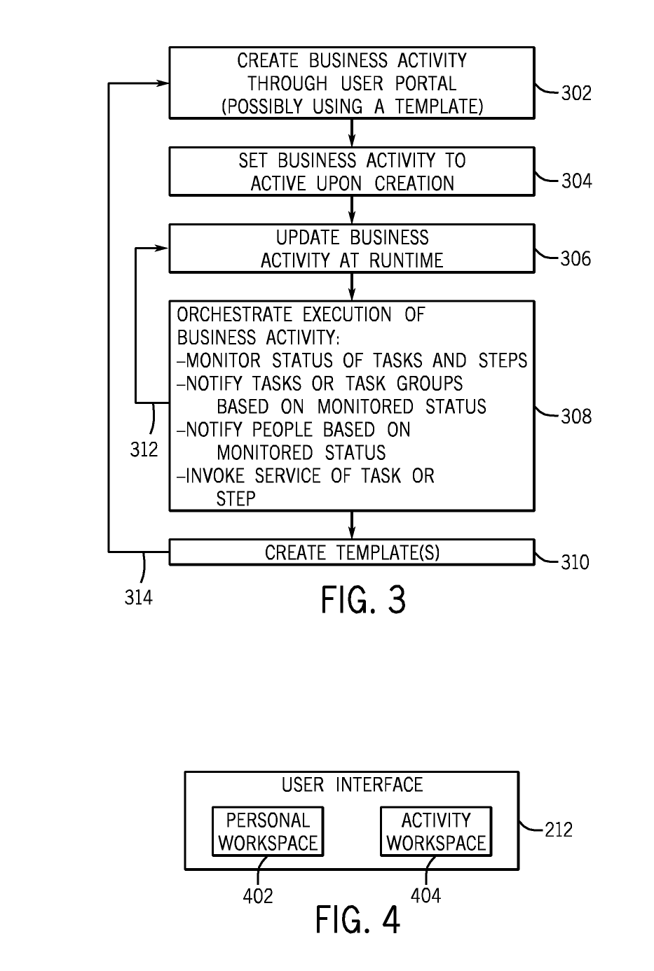

FIG. 3 is a flow diagram of a business activity management process according to further embodiments which can be performed by components of the business activity manager 200. In response to inputs in the user portal 202, a new business activity is created (at 302), such as by calling a corresponding API in the interface layer 204 of FIG. 2. A template (discussed further below) can be used to make creation of the new business activity easier for a user. A business activity can have a collection of tasks and/or task groups. Each task can further be refined into steps. A business activity is considered on-going from the time that the business activity is created; in other words, the business activity is set (at 304) to a status of “active.”

Once a new business activity is created and executing, the business activity can be updated (at 306) as the business activity executes. In some implementations, the updates of business activities can be performed using API (Application Programming Interface) calls to the interface layer 204 of FIG. 2. The API calls can be triggered by events in the user portal 202 or the business activity orchestrator 208. An event triggered in the user portal 202 can be based on user input at a user interface 212. An API call triggered by an event in the business activity orchestrator 208 can be based on an automated decision by the orchestrator 208 to cause an update of the business activity, such as based on some predefined rule.

The following are some examples of updates that can be performed using respective API calls. Note that specific characteristics regarding the listed types of updates are described for purposes of example. In other examples, the updates can have other characteristics, or there can be additional or alternative types of updates.

A business activity can be updated by adding a task to the business activity. Each task has a set of properties such as start-date, due-date, end-date, status, actor identifiers, documents, dependsOn, and type. Actor identifiers identify the persons involved with the task; an actor identifier can also specify a role of the person. Possible roles can include “responsible” (a person assigned this role is responsible for performing the task), “accountable” (a person assigned this role is ultimately accountable for the successful completion of the task), “consulted” (a person assigned this role can be asked to assist with the task), and “informed” (a person assigned this role is to be informed of a status of the task), as some examples. The status of a task is one of “allocated” (the task has been created), “started” (the task has started), “finished” (the task has completed), or “inactive” (the task is not active). Documents associated with a task are the documents that are used, manipulated or generated by the task. A task can be of two types: “human” or “automated.” By default tasks are defined as type “human” (which means that the task is performed by a human). If a task is defined as type “automated” (which means the task is automatically performed), then an API call can be made to a web service or other service at runtime to perform the task.

The property “dependsOn” contains the list of other tasks or task groups that this task depends on. There are two main types of dependencies: mandatory (either OR or AND) and notification. With the mandatory type, the dependent task cannot be started unless the depended-on task is finished. With the notification type, upon the completion of the depended-on task the actors of dependent tasks are notified. Note that the mandatory dependency defines ordering constraints on the execution of tasks or task groups, while the notification type does not define ordering constraints.

Another type of business activity update involves updating the properties of a task. Properties such as start-date and end-date are filled automatically. Other properties such as status, actor identifiers, documents and dependsOn can be modified by a user. A user updates a task's properties through the user portal 202.

Another type of business activity update involves adding a task group. A task group includes a set of tasks or other task groups. The task group can be a placeholder for a set of tasks for which the details of the tasks are not known yet. A user can add a task group. A task group that is added has a parent, which either can be a task group or the business activity. A task group has the properties of start-date, due-date, end-date, status, actor identifiers, and documents. A task group can have a status of “defined,” “started,” “finished,” or “inactive.” A user who creates the task group is by default added to the list of actor identifiers with the role of “accountable.”

Another type of business activity update involves removing a task group. Removing a task group triggers an event so that a message is sent to all persons in the list of actor identifiers of this task group and all the tasks (groups) that depend on this task group to inform them of the request for this task group's deletion. The message is visible in an activity workspace in the user portal (an “activity manager” is discussed further below); also, the message can be sent by email. The message asks the recipients to react if they object to the removal of the task group. If no one objects to the removal of this task group within a predefined time period, this task group is removed from the business activity. The dependency list of tasks (or task groups) that depend on the removed task group is updated. Note that any removed task group is assigned the status of “inactive,” which means that it is not part of ongoing business activity. The inactive task group is not shown in any workspace but exists in the history of the business activity in the business activity repository 210. The (previously removed) task group can be restored to the “active” status via the user portal 202.

Another type of business activity update is removing a task, which is similar to removing a task group, except just an individual task is removed.

Another type of business activity update is adding a step. A step is the smallest unit of work to accomplish some part of a task. A user can create a step associated with a task. By default the steps for a task are ordered according to an order of their execution. A step has the properties of start-date, end-date, due-date, type, status, and actor identifiers. By default all steps are assigned to people (identified by the corresponding task's actor identifiers) who are “responsible” or “accountable.” Similar to a task, a step can be of type “human” or “automated.”

Another type of business activity update is removing a step. Removing a step is similar to removing a task. All persons who have either the “responsible” or “accountable” role for the task are notified for possible objection, and if no objection is raised, the step is removed from the list of steps of the corresponding task and the step's state is updated to “inactive.”

Another type of business activity update is updating a step, which enables a user to update properties of a step including start-date, due-date, and status.

Another type of business activity update is a membership request to join a business activity, which allows a user to request to join a team working on a business activity. The membership request is sent to the person(s) with an “accountable” role in the business activity for approval. After approval, a workspace is created for the person.

Another type of business activity update is adding or removing a team member, which allows the person(s) with “accountable” role in the business activity to send an invitation to a new person to join the business activity or to remove the person from the business activity. In case the person is removed, the workspace of the person is assigned the status of “inactive” and this person is removed from actor identifiers of relevant tasks.

Referring again to FIG. 3, execution of a business activity is orchestrated (at 308) by the business orchestrator 208. The business activity orchestrator 208 is able to monitor the status of tasks and steps of a business activity. A task is considered complete (finished) either when all steps of the task are completed or when the task is marked as finished by a user. In response to detecting completion of a task, the business activity orchestrator 208 notifies all the tasks or task groups that are dependent upon the completed task. Upon completion of a task, designated people can be notified of the completion. If a task or step is of type “automated,” an API can be called to invoke a corresponding web service or other service, and a response (either a success response or error response) is provided by the web service or other service back to the personal workspace of each involved team member.

For ease of creating other business activities, an existing business activity that is running can be abstracted and saved to create (at 310) an activity template for subsequent use. An activity template (or more simply “template”) is an activity definition in which the highest level task groups and tasks are defined. Details regarding the execution or progress of business activities (and assigned roles) are removed from the template, with task group, task, and step definitions saved. The templates (214 in FIG. 2) can be saved in the business activity repository 210. In some implementations, the templates 214 can be used to store information relating to best practices (best practices are discussed above). By providing information about best practices in templates 214, definitions of business activities according to some implementations can leverage such best practices such that collaborative execution of the business activities can take into the corresponding best practices.

FIG. 3 further shows an arrow 312 going from box 308 to box 306, and another arrow going from box 310 to box 302. The arrow 314 indicates that a created template is also used to initiate new business activity (during runtime). The arrow 312 represents a continual process of orchestrating and updating the definition of the business activity (during runtime).

As shown in FIG. 4, a user interface 212 of the user portal 202 includes a personal workspace 402 for a team member, where the personal workspace can retrieve and show the tasks allocated to a corresponding member. Different team members are associated with corresponding individual personal workspaces. Each personal workspace 402 enables the respective team member to update the status of tasks (and steps) associated with the respective team member as the tasks (or steps) progress.

For a particular task allocated to a team member, the personal workspace 402 can show the list of all tasks (or task groups) that the particular task depends on, as well as all tasks (or task groups) that depend on the particular task. The personal workspace 402 for a task can provide a “last updates” section where all the latest changes related to the particular current task are shown (changes to the tasks or task groups that the particular task depends on as well as completion/update status of the steps of the particular task). Through this personal workspace 402, the team member can add, remove, and/or update task groups, tasks, and steps within tasks.

The user interface 212 can also present an activity workspace 404 provided to all team members so that the team members can see the status and progress of the business activity. The activity workspace 404 is a common workspace presented in various user interfaces 212 of the corresponding team members. While the activity workspaces 404 in corresponding user interfaces 212 show common information to the team members of the business activity, the personal workspaces 402 can depict different information relevant to corresponding team members.

The activity workspace 404 can also be used by the team members to update the definition of the business activity, through use of the business activity adapter 206 (FIG. 2). The activity workspace 404 can show the list of currently started tasks (and/or task groups), the tasks that are due or overdue, as well as dependencies among tasks. Team members can also see dependencies and status of progress of tasks, such as based on a dependency graph that depicts dependencies among tasks (groups).

The following describes specific examples in the context of business outsourcing, where outsourcing refers to a first organization engaging a second organization to perform target business activity(ies). The first organization is the outsourcing organization, while the second organization is the outsourced organization. Outsourcing personnel of the outsourcing organization uses the user portal 202 (FIG. 2) to create a new business activity (for the purpose of outsourcing work to the outsourced organization).

The business activity manager 200 can ask the outsourcing personnel whether the new business activity is defined based on a template. For example, the business activity manager 200 can present a list of templates for selection by the outsourcing personnel. If a template is selected, then the new business activity is created based on the selected template.

Below is an example definition of a template which can be stored in the business activity repository 210:

<Activity name=”” start-date=”” end-date=”” due-date=”” status=”” ...>

<task name=”” start-date=”” end-date=”” status=”” actorId=””...>

*<document=”URL” .../>
*<steps>...</steps>
*<depends on=”task-group” type=””.../>

</task>

...

<task-group start-date=”” end-date=”” due-date=”” status=””>

<task>... </task>

....

*<document=”URL”.../>
* <depends on=”task-group” type=””.../>

</task-group>

...
</Activity>

If a template is used, task group(s) and/or task(s) of a previous business activity (represented by the selected template) are presented in a user interface 212 of the user portal 202. The presented task group(s) and/or task(s) can be updated by the outsourcing personnel, and additional task group(s), task(s), and step(s) can be added.

During creation of the business activity, team members can also be added. Team members can include personnel from both the outsourcing and outsourced organization. A business activity is considered “active” from the moment that the business activity is defined.

Some implementations of the business activity manager 200 provide some of the following benefits. Runtime adaptation of on-going business activities can be performed, such that predefinition of business activities does not have to be provided, and the definitions of business activities can be updated as the business activity is ongoing (during execution). The business activity manager 200 enables definition of ad-hoc business activities that are not well-structured. The business activity manager 200 allows defining business activities as they are being performed during their day-to-day operations.

The business activity manager 200 provides a flexible technique in which business activity definition is performed in a collaborative manner between team members. This technique allows capturing the knowledge and expertise of all team members in conducting the business activity.

Consensus-based task update and removal can be provided. The business activity manager 200 provides a consensus based technique through which certain changes including the removal of tasks (groups) and steps are performed based on agreement among the team members.

The business activity manager 200 is able to monitor the progress of tasks and steps and can analyze the dependencies between them to enable the start of other tasks and notify people of their progress.

Business activity knowledge can be captured as templates for subsequent use, to allow improved efficiency. This allows the capturing of the knowledge of other people for sharing when performing similar business activities in the future.

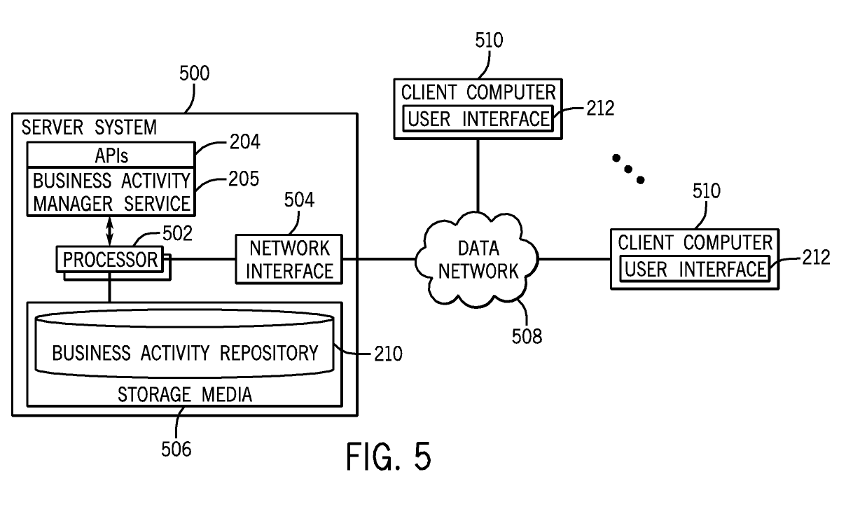

FIG. 5 illustrates an example arrangement that includes a server system 500 coupled over a data network 508 to client computers 510 that are able to access the server system 500. The server system 500 can be implemented with a computer system, such as a system having a single computer node, or a system having distributed computer nodes. The server system 500 includes components of the business activity manager 200 of FIG. 2, including the APIs 204 and the business activity manager service 205. The APIs 204 and business activity manager service 205 can be implemented using machine-readable instructions executed on one or multiple processors 502 of the server system 500. The processor(s) 502 is (are) connected to a network interface 504 (to allow the server system 500 to communicate over the data network 508), and to a storage media 506 that stores the business activity repository 210. The storage media 506 can be implemented with disk-based storage media or other types of storage media.

The user interfaces 212 of the user portal 202 (FIG. 2) are implemented in corresponding client computers 510.

Machine-readable instructions discussed above are loaded for execution on a processor (e.g., 502). A processor can include a microprocessor, microcontroller, processor module or subsystem, programmable integrated circuit, programmable gate array, or another control or computing device.

Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture).

An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method of dynamically adapting a business activity in a business activity management system, comprising:
creating a first business activity by receiving, through a user portal, user input relating to creation of the first business activity, wherein the first business activity involves interactions among people;
orchestrating, by a business activity orchestrator executed in a computer system, execution of work in the first business activity; and
updating the first business activity using a business activity adapter executed in the computer system, wherein updating the first business activity occurs during execution of the first business activity as orchestrated by the business activity orchestrator, and the updating is responsive to collaborative input of the people involved in the first business activity,
wherein creation and updating of the first business activity are performed in an ad-hoc and collaborative manner as the first business activity executes.

2. The method of claim 1, further comprising iteratively repeating the receiving, orchestrating and updating tasks on a continual basis.

3. The method of claim 2, wherein updating the first business activity is responsive to at least one of: (1) events triggered by inputs made by the people in respective user interfaces of the user portal; and (2) events triggered by the business activity orchestrator.

4. The method of claim 1, wherein updating the first business activity comprises at least one selected from among:
adding a task to the first business activity, updating a task of the first business activity, removing a task from the first business activity, adding a group of tasks to the first business activity, removing a group of tasks from the first business activity, adding a step to a task of the first business activity, removing a step from a task of the first business activity, updating a step of a task of the first business activity, joining a user to the first business activity, and removing a user from the first business activity.

5. The method of claim 1, wherein receiving the input through the user portal relating to creation of the first business activity comprises receiving collaborative input from multiple persons through respective workspaces provided by the user portal, and
wherein updating the first business activity is performed collaboratively by the multiple persons through the respective workspaces.

6. The method of claim 1, wherein creation and updating of the first business activity in an ad-hoc and collaborative manner allows for the dynamic adaptation of the first business activity without having to provide a predefined definition of the first business activity.

7. The method of claim 6, wherein creating and updating the first business activity are performed without predefining a fixed model of the first business activity that has to be manipulated by any one of the people.

8. The method of claim 1, further comprising:
providing personal workspaces in the user portal for respective members of the people associated with the first business activity; and
presenting, through each personal workspace, tasks of the first business activity associated with the corresponding member.

9. The method of claim 8, further comprising:
for a particular one of the tasks allocated to a given one of the members, presenting in the personal workspace of the given member other tasks that the particular task depends on, and presenting other tasks that depend on the particular task.

10. The method of claim 9, further comprising providing plural types of dependencies between the tasks, wherein the plural types of dependencies include:
a first type of dependency in which a dependent task cannot be started unless a dependent-on task is finished, and
a second type of dependency in which notification is provided upon completion of a depended-on task.

11. The method of claim 9, further comprising:
for the particular task, presenting in the personal workspace of the given member changes related to the other tasks that the particular task depends on.

12. The method of claim 8, further comprising:
presenting, in an activity workspace of the user portal, information relating to the first business activity, wherein the activity workspace is presented to the members and contains common information.

13. An article comprising at least one machine-readable storage medium storing instructions that upon execution cause at least one processor in a business activity management system to:
create a business activity that involves interaction among team members that are to perform the business activity, wherein the team members include personnel from one organization or from multiple organizations;
upon creating the business activity, set the business activity to an active state to allow execution of the business activity; and
during execution of the business activity, adapting the business activity by updating the business activity in response to collaborative actions of the team members.

14. The article of claim 13, wherein updating the business activity comprises updating tasks or groups of tasks of the business activity.

15. The article of claim 14, wherein the instructions upon execution cause the computer system to further present personal workspaces for the respective team members, wherein each personal workspace contains tasks and/or task groups associated with the corresponding team member.

16. The article of claim 13, wherein adapting the business activity comprises at least one selected from among:
adding a task to the business activity, updating a task of the business activity, removing a task from the business activity, adding a group of tasks to the business activity, removing a group of tasks from the business activity, adding a step to a task of the business activity, removing a step from a task of the business activity, updating a step of a task of the business activity, joining a user to the business activity, and removing a user from the business activity.

17. The article of claim 13, wherein the instructions upon execution cause the computer system to further:
monitor status of tasks in the business activity during execution;
notify at least one of the team members of the status based on role assigned to the at least one team member; and
define dependencies among the tasks.

18. A business activity management system comprising:
at least one processor;
an interface layer executable on the at least one processor to allow communication with user interfaces of a user portal; and
a business activity manager service executable on the at least one processor to:
receive, through the user portal, input to create a particular business activity, wherein creating the particular business activity is based on user selection of one of multiple templates representing corresponding prior business activities, and wherein the particular business activity involves interactions among team members;
set the particular business activity to active upon creation of the particular business activity, to allow the particular business activity to execute;
during execution of the particular business activity, receive user input from the team members to update the particular business activity; and
save a further template based on the particular business activity for subsequent use.

19. The system of claim 18, wherein the business activity manager service is executable to further:
create a template based on the particular business activity, wherein the created template includes tasks of the particular business activity; and
create a second business activity using the template.

20. The system of claim 18, wherein the business activity manager service is executable to further:
track work of the particular business activity; and
coordinate a flow of tasks of the particular business activity among the people.
